(19) United States
(12) Patent Application Publication
(10) Pub. No.: US 2016/0167470 A1
(43) Pub. Date: Jun. 16, 2016

(54) GLIDING MOBILE, IN PARTICULAR HYDROFOIL, PROPELLED BY A ROTARY-WING DRONE

(71) Applicant: PARROT, Paris (FR)

(72) Inventors: Henri Seydoux, Paris (FR); Jean Etcheparre, Trevose Park (SG)

(21) Appl. No.: 14/941,263

(22) Filed: Nov. 13, 2015

(30) Foreign Application Priority Data
Dec. 11, 2014 (FR) 14 62223

(51) Int. Cl. B60F 3/00; B64C 39/02; B62M 27/02; B63H 7/02

(52) U.S. Cl. CPC B60F 3/0076; B63H 7/02; B64C 39/024; B60F 3/0038; B62M 27/02; B64C 2201/024; B64C 2201/108; B64C 2201/12; B62M 2027/023

(57) ABSTRACT

The mobile comprising a gliding static structure (100) provided in a lower region with a set of gliding elements (110, 120g, 120d). It further includes means (300) for the removable mounting of a rotary-mind drone with multiple rotors (221-224) forming a propulsion group (200), whose rotors each exert a thrust with a component according to a main axis (X-X) of gliding of the mobile, the proportional and individualized drive of the rotors (221-224) allowing the piloting of the mobile in speed and direction with no rudder.

The present invention generally relates to rotary-wing gliding mobiles, and in particular mobiles gliding on water, on snow or on ice, by being driven by an aerial propulsion unit.

Such mobiles are already known, such as the small-scale models used for fun or utility purposes. Such a mobile comprises a propeller providing a thrust in the main direction of displacement, a set of hulls forming a catamaran or trimaran structure, and a rudder allowing to ensure the changes of direction. Other small-scale models have an aquatic propeller.

WO 02/060550 A1 and US 2007/0010159 A1 describe such a type of mobile, including two independently controllable propellers, mounted on a common hull.

The present invention aims to propose a gliding-displacement mobile whose structure is simple and robust, with no mobile parts, which can take advantage of a pre-existing drone to ensure a simple, intuitive and varied piloting of such as drone, both for fun or for utility purposes.

It is proposed for that purpose a mobile comprising, as disclosed in above-mentioned WO 02/060550 A1, a gliding static structure provided, in a lower region, with a set of gliding elements.

Characteristically of the invention, the mobile further comprises means for the removable mounting of a rotary-wing drone with multiple rotors forming a propulsion unit, the rotors being adapted to each exert a thrust with a component according to a main axis of gliding of the mobile, the proportional and individualized drive of the rotors allowing to pilot the mobile in speed and direction.

Certain preferred but non-limitative aspects of this mobile comprise the following characteristics, taken individually or according to any combination that the one skilled in the art will comprehend as being technically possible:
the gliding static structure is a mechanical structure devoid of orientable directional member, and devoid of electronic propulsion and/or direction control and driving means;
the mounting means comprise an arm articulated about an axis transverse to the main axis of gliding of the mobile;
the arm is free in rotation, and stop means are provided for retaining the propulsion unit in a wording position fixed with respect to the structure when the rotors are driven into rotation, the rotors being adapted to generate a thrust with a component in the main axis of gliding of the mobile;
the drone is a pre-existing multicopter or a quadricopter used with no other modification than the adaptation of its control software to the progression and the direction of the mobile;
when the drone is a quadricopter, the rotors are able, driven into rotation, to progressively make, under the only effect of their thrust, the propulsion unit switch from a storing position to said working position;
when the drone is a quadricopter, in working position, a differentiated drive of two pairs of rotors located on the left and the right, respectively, with respect of the main axis of displacement is adapted to control the mobile in direction without having to control the orientation of a rear squat keel, and/or a differentiated drive of two pairs of rotors located farther from and closer to the structure, respectively, is adapted to control the mobile in attitude;
the structure is adapted to an aquatic displacement and has squat keels;
the mobile comprises at least one front squat keel with a positive incidence angle;
the mobile comprises at least one rear squat keel with a negative incidence angle;
the mobile comprises two front squat keels forming together a “V” configuration;
the front squat keels are mounted on two lateral stabilizers extending from a main central structure, oriented angularly downward and towards each other;
the mobile comprises a rear squat keel in an inverted “T” shape;
the structure defines at least one front floating volume adapted to oppose a moment exerted by the thrust of the propulsion unit, tending to give it a diving attitude;
the centre of gravity of the mobile is located behind a centre of application of the thrust of the propulsion unit with respect to the main axis of gliding of the mobile;
the mobile comprises a set of at least three pads for a displacement on snow;
the mobile comprises a set of at least three blades for a displacement on ice;
the mobile comprises means for the removable mounting of the keels, adapted to alternatively receive the pads or the blades.

Other aspects, objects and advantages of the present invention will appear more clearly from the following detailed description of preferred embodiments thereof, given by way of non-limitative example and with reference to the appended drawings.

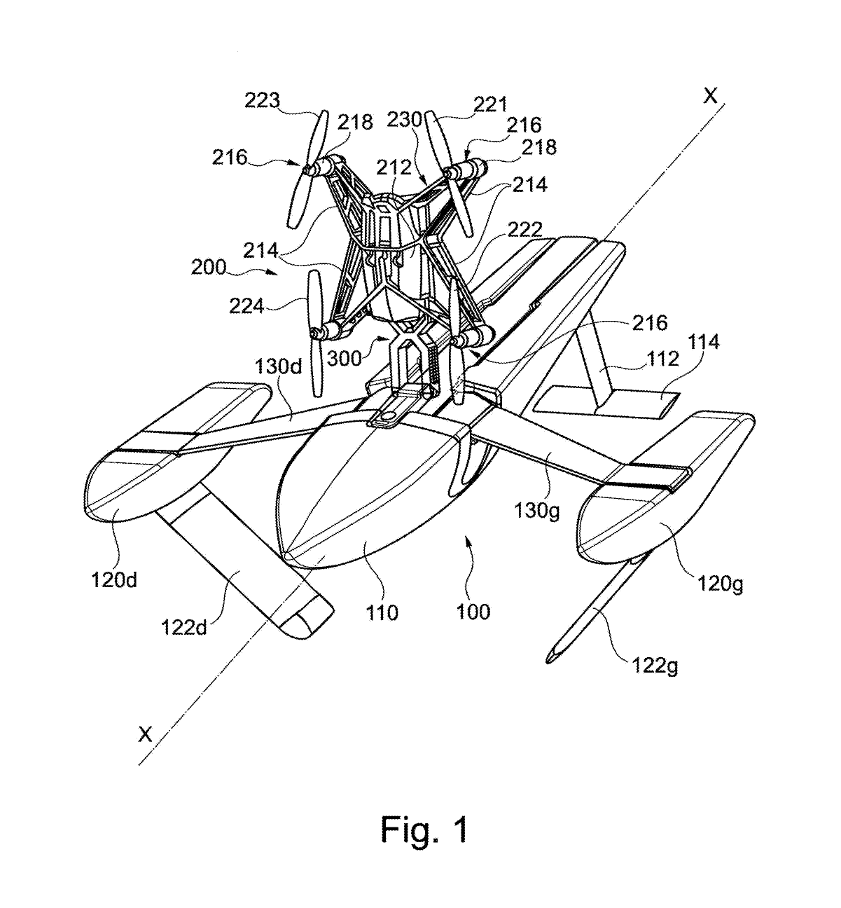

FIG. 1 is a perspective view of a mobile according to the invention, intended to move on water, in a position of displacement.

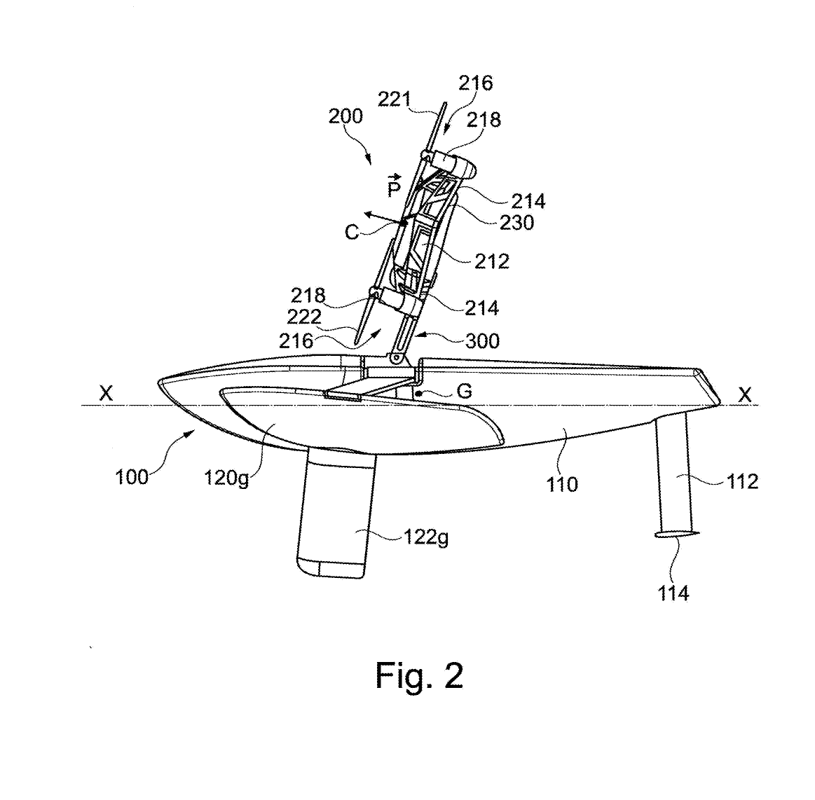

FIG. 2 is a side elevation view of the mobile of FIG. 1.

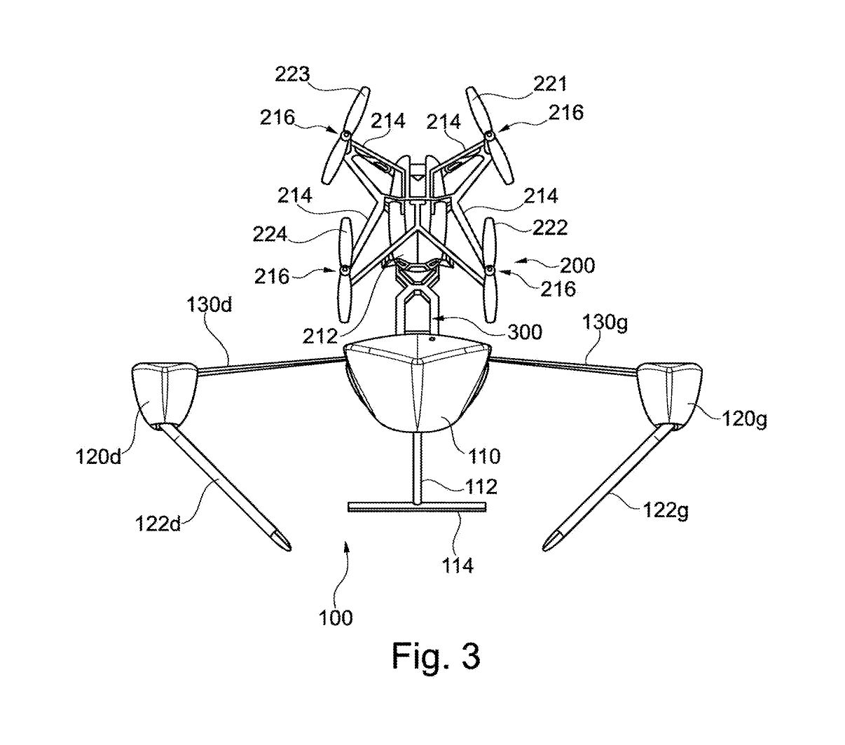

FIG. 3 is a front elevation view of the mobile of FIGS. 1 and 2.

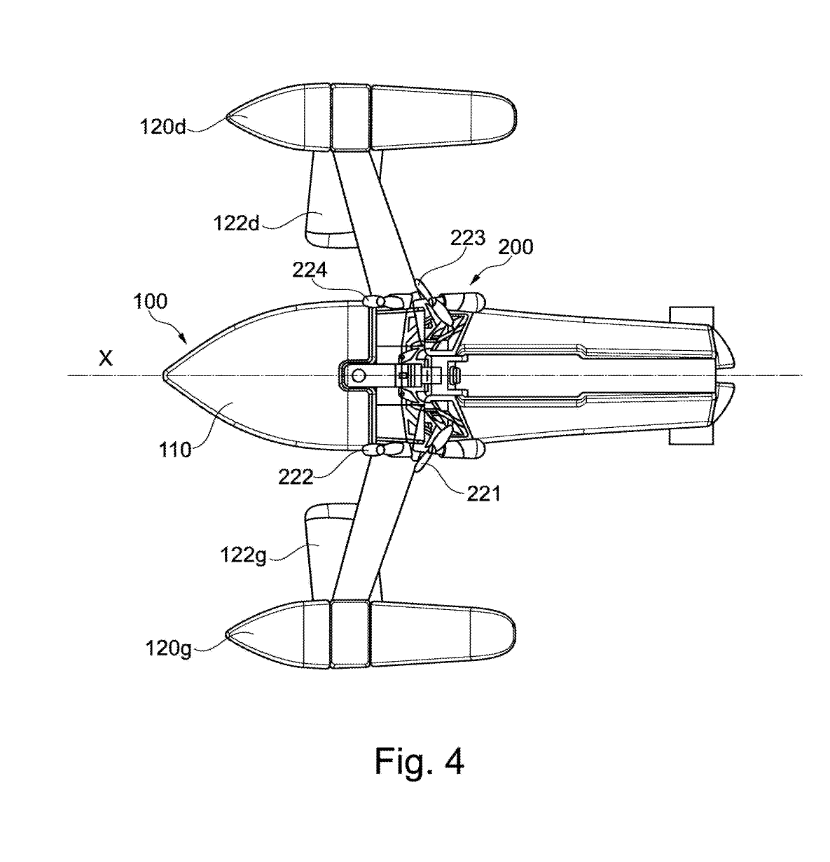

FIG. 4 is a top view of the mobile of FIGS. 1 to 3.

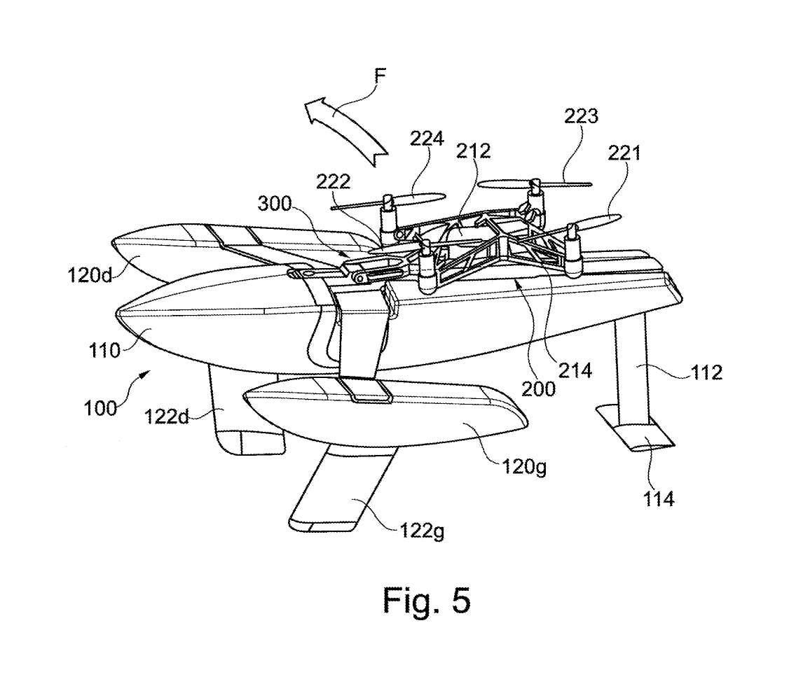

FIG. 5 is a side perspective view of the mobile of FIGS. 1 to 4, in a rest position.

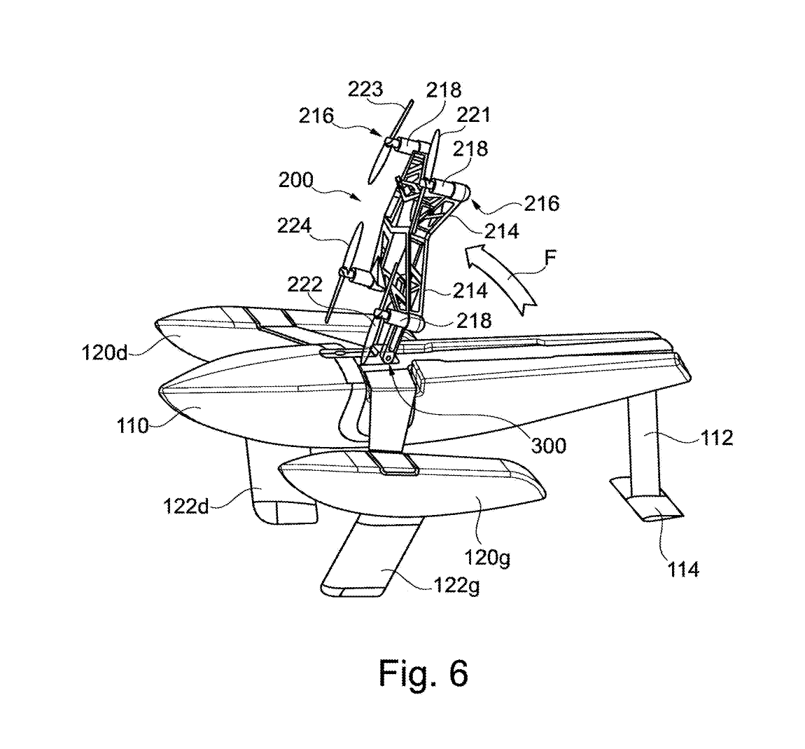

FIG. 6 is a view according to the same orientation as FIG. 5, but in the position of displacement of the mobile.

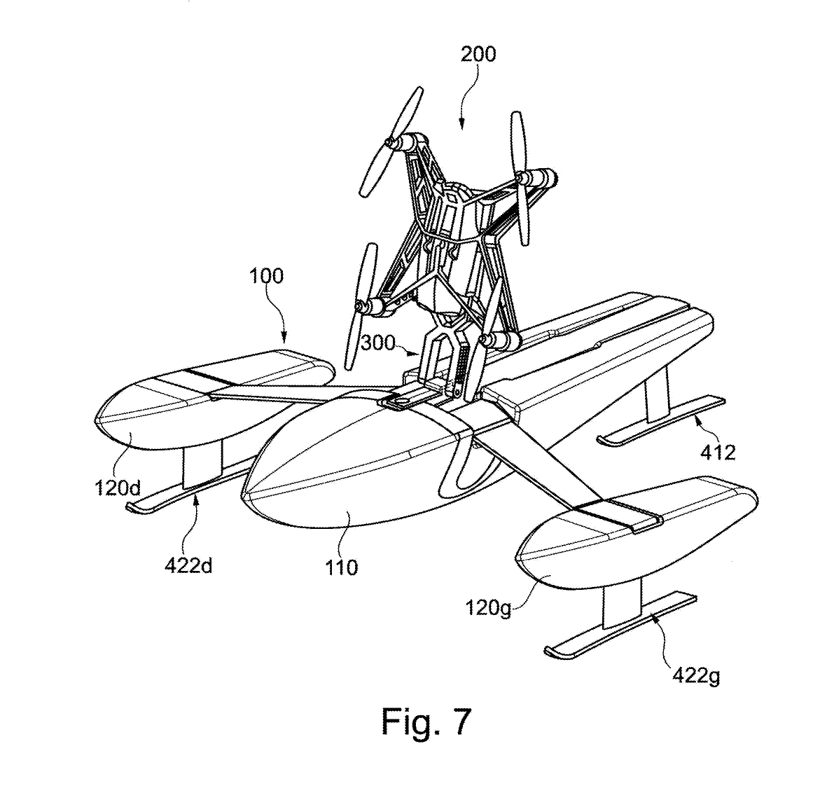

FIG. 7 is a perspective view of a mobile according to a first variant of the invention, intended to move on snow.

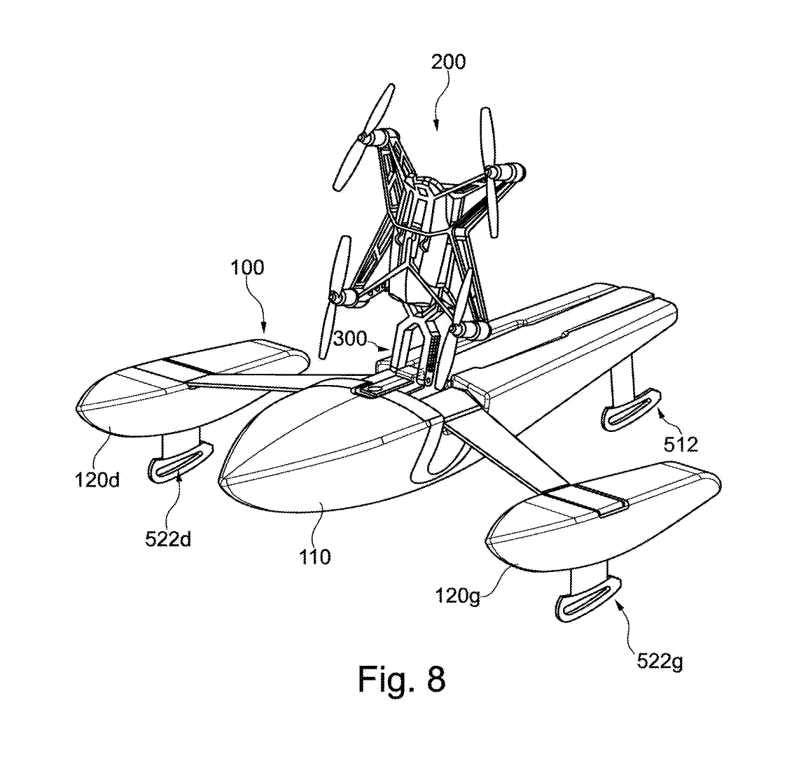

FIG. 8 is a perspective view of a mobile according to a second variant of the invention, intended to move on ice.

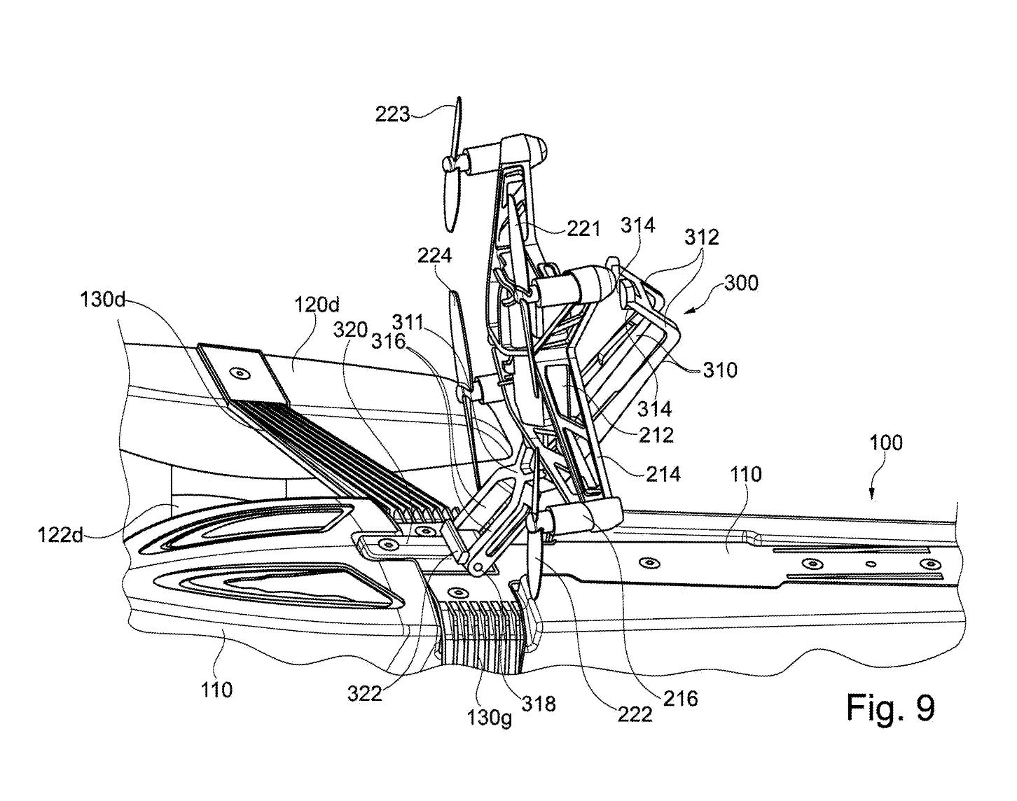

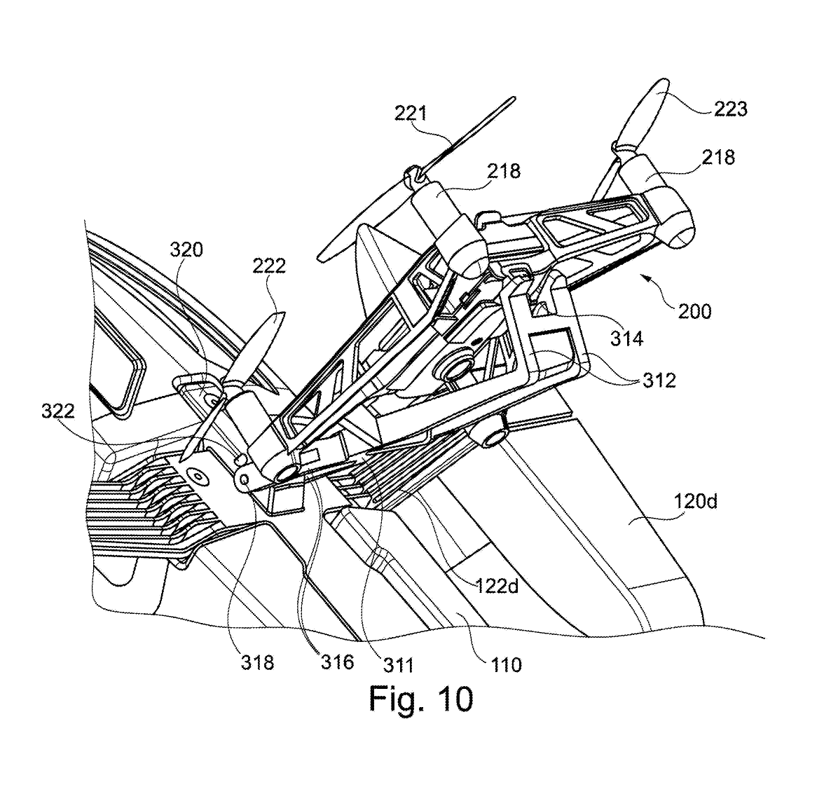

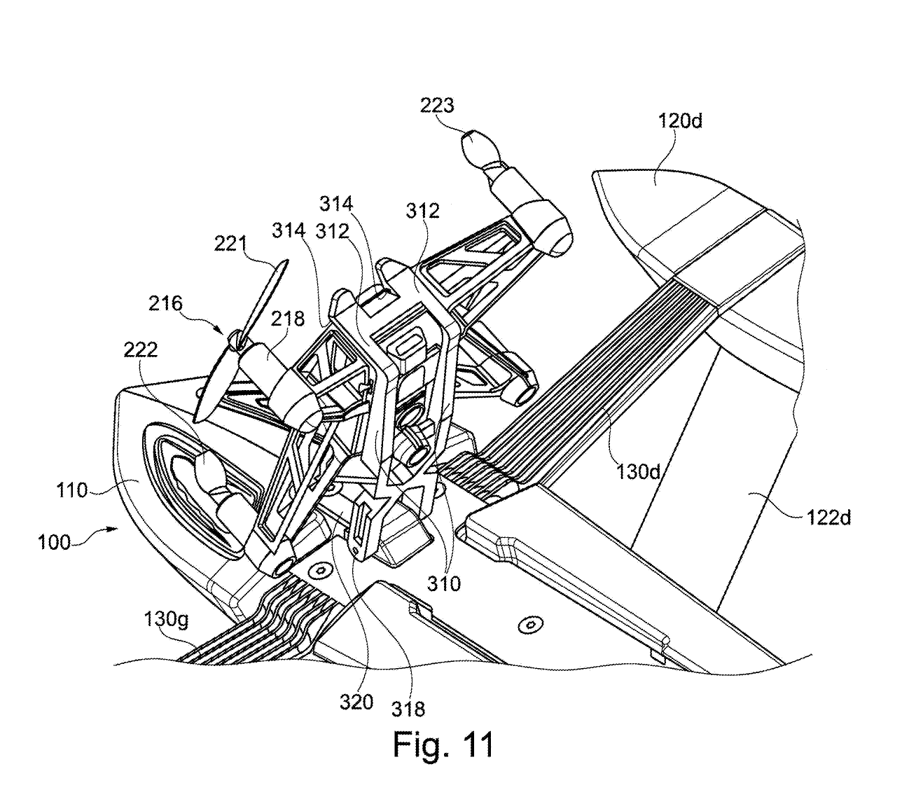

FIGS. 9 to 11 are three perspective views illustrating in detail the fastening of a propulsion unit on the mobile of FIGS. 1 to 8.

With reference to FIGS. 1 to 6, a mobile intended to move on water under the action of an aerial propulsion unit is shown. It comprises a multi-hull flotation and navigation structure of the “hydrofoil” (hydropter) type, wholly denoted by the reference 100, a propulsion unit 200 and means 300 for the removable fastening of the propulsion unit to the structure.

The structure 100 is herein of the trimaran type, symmetrical with respect to a main axis of gliding X-X of the structure, with a hollow central part 110 essentially formed of a hull and a bridge, a left stabilizer 120g connected to the central part by an arm 130g, and a right stabilizer 120d connected to the central part by an arm 130d. The stabilizers 120g, 120d are also hollow parts essentially formed of a hull and a bridge.

The structure 100 is preferably made of a plastic material. The arms 130g, 130d are advantageously longitudinally ribbed for stiffening purposes, as illustrated in FIGS. 9 to 11.

The left and right stabilizers 120g, 120d include squat keels 122g, 122d, oriented angularly, in a re-entrant way, from a lower region of the stabilizers. These keels are arranged in the front region of the stabilizers.

The central part 110 includes, in the rear region of its hull, a T-shaped keel with a vertical part 112 and 114.

The keels 122g, 122d, 112 and 114 are fixed and have preferentially standard profiles of the NACA (National Advisory Committee for Aeronautics) type or the like.

It is observed that the structure 100 has no rudder or rudder blade, the directional piloting being ensured by control of the aerial propulsion unit. The parameters of positioning and inclination of the various keels will be described in more details hereinafter.

Advantageously, the aerial propulsion unit 200 is consisted by a commercial drone of the quadricopter type, in this case by a “mini-drone” known under the name Rolling Spider marketed by Parrot S A, Paris, France.

In a manner known per se, this drone comprises a central body 212 housing a removable battery and a circuitry for control and wireless communication with a remote control device, from which radiate four support arms 214. Each support arm 214 is equipped at its distal end with a propulsion unit 216 comprising a motor 218 driving into rotation a propeller, 221, 222, 223 and 224, respectively, the propellers extending in a plan that is offset with respect to that of the support arms 214.

The four motors 221 to 224 are piloted independently from each other by an integrated navigation and direction control system, as will be seen hereinafter.

Such an aerial propulsion unit may be advantageously piloted through a terminal such as a touch-screen phone or multimedia player with an integrated accelerometer, for example a cellular phone of the iPhone type or a multimedia tablet of the iPad type (registered trademarks of Apple Inc., USA). Those devices incorporate the various control members required for the detection of the piloting commands and the bidirectional exchange of data with the propulsion unit via a wireless link of the Bluetooth or Wi-Fi (IEEE 802.11) local network type (registered trademarks). They are further provided with a touch screen allowing to display a certain number of symbols for the activation of commands by simple contact of the user's finger on this touch screen.

Inertial sensors (accelerometers and gyrometers) measure precisely the angular speeds and the attitude angles of the propulsion unit, and hence of the whole mobile on which it is secured, as will be seen hereinafter.

With reference to FIGS. 9 to 11, three perspective views of the way the propulsion unit 200 is mounted on the flotation and navigation structure 100 are shown. An arm, generally denoted by the reference 300, is mounted in an articulated way about an axis 318 oriented transversely to the axis of progression of the mobile. This arm includes two generally parallel lateral branches 310, 310, oriented perpendicular to the axis of articulation 318 and forming together a cradle into which the central body 212 of the propulsion unit can intimately settle, by its lower face opposed to the propellers.

This cradle is continued, on the side of the free end of the arm, by two locking tabs 312, 312 oriented substantially at right angles with respect to the branches 310, 310 and ending by two locking teeth 314, 314 adapted to hook on pre-existing arrangements (not visible) provided on the top of the central body 212 of the propulsion unit.

Towards the axis of articulation 318, the cradle defined by the branches 310, 310 is continued, beyond an area 311 where the branches 310, 310 are connected to each other, by two other branches 316 passes through, in the region of their free ends, by circular orifices into which the axis 318 is engaged.

The mounting of the propulsion unit 200 on the structure 100 is performed in an extremely simple way by slightly pressing the central body 212 of the unit into the cradle formed by the arms 310, until the teeth 314 come and hook on the top of the body 212 and lock the propulsion unit 200 in its cradle. It is important that this mounting is performed with no clearance, so that the control of the propulsion unit to drive the mobile is performed the most accurately possible, with no spurious vibrations, as will be seen in detail hereinafter.

The dismounting of the propulsion unit is performed simply by pull the locking tabs 312, 312 by means of the fingers, to disengage the teeth 314, 314 and to release the propulsion unit.

Besides, it is provided a stop device for the arm 300, as a part 320 fastened to the bridge of the central structure part 110 and that has a rigid bead 322 oriented parallel to the axis of articulation 318. When the arm 300 pivots from a position generally directed towards the rear of the mobile to an up-right position, the bead 322 locks the angular displacement of the arm, and hence of the propulsion unit 200 it supports, in a quite accurate angular position, as will be seen hereinafter.

The operation, piloting and behaviour of the aquatic mobile as described hereinabove will now be explained.

Firstly, it has been seen that the mobile had no directional member in contact with water, the left-right directional control being ensured by driving the left 221, 222 and right 223, 224 propellers in a differentiated manner—a higher thrust with the left propellers leading to a change of direction to the right, and reverse.

This piloting is advantageously performed by a suitable programming of the remote-piloting terminal, the changes of direction being ensured by simple touch commands, or by inclination of the terminal, with preferentially a progressive drive.

Secondly, the use of a propulsion unit having propellers located at different heights allows to regulate the pitch attitude of the mobile, a higher thrust with the highest propellers allowing the lower the front of the mobile, whereas an increased thrust with the low propellers allows on the contrary to pull out the mobile when it tends to pitch down.

Advantageously, this pitch attitude control is performed automatically thanks to the inertial sensors equipping intrinsically the propulsion unit. This pitch piloting is particularly advantageous in that it allows, with a set of squat keels that are all fixed, to have the same effect as the orientation-control squat keels as in certain known hydrofoils.

It is understood from what precedes that the structure 100 of the mobile may be a simple mechanical structure with no mobile navigation parts and totally deprived of electronics, which advantageously gives it robustness, light weight and low cost.

As for the keels 112, 114, 122g and 122d, they are placed and sized in such a way that, when the propulsion unit exerts its thrust by means of the propellers, the mobile rapidly squats to reach a “flying” position (flying over the stretch of water), the contact with the aquatic medium existing only through the keels, with hence an extremely limited drag and a high speed of displacement, even in the presence of a limited thrust force.

It will be noted that the configuration of the keels, with a “V”-shaped front keel structure extending from two lateral stabilizers and an inverted “T”-shaped rear keel structure extending from the central structure, is a freestanding structure if the incidence angles of the keels are suitably adjusted.

It is comprised that the squat is produced if the attack angles of the front keels 122g, 122d are positive with respect to the surface of water. During this phase, the floating volume of the central hull and of the stabilizers in the front region of the mobile also contributes to the squat and avoids the digging in, in particular in the hypothesis where a change of attitude of the mobile at the front of the mobile, linked for example to the agitation of the sketch of water, would generate a negative attack angle.

Moreover, being observed that the thrust centre of the propulsion unit 200 is located at the central body 212 of the latter and hence far above the flotation level before the squat, it is required to counter the effect of forward tilting, in diving, caused by the moment of this thrust.

Generally, satisfying squat and take-off are ensured at the starting of the propulsion unit thanks to a combination of the following characteristics:
positioning of the centre of gravity G of the mobile behind the lift centre C, where the thrust P is applied (see FIG. 2), i.e. conversely to what is done for aircrafts;
positive angle of incidence of the front keels 122g, 122d, as seen hereinabove, with a value typically comprised between 3° and 10° and, preferably, close to 6°, with the configuration illustrated in the drawings;
slightly negative angle of incidence of the horizontal part 114 of the rear keel, with a value typically comprised between −1° and −5°, and preferably close to |3°, with the configuration illustrate d in the drawings, so as to here again contribute to oppose the tilting moment linked to the thrust when the mobile begins to move;
use of a sufficient floating volume on the front to at least compensate for the tilting moment, as also seen hereinabove, in particular at the beginning of the moving whereas the speed is still low and the effect of the angle of incidence of the keels is only starting;
orientation of the thrust both forward and upward, thanks to the slightly inclined positioning of the plan of the propellers with respect to a plan perpendicular to the horizontal axis of the mobile (see in particular FIG. 2); this inclination, ensured thanks to the stop part 320, is advantageously comprised between 10° and 25°, and preferably close to 15° with the illustrated configuration.

It will be noted that, in the case where the drone constituting the propulsion unit 200 has sensors (camera, ultrasound altimeter, etc.) intended to be used in aerial flight mode, these latter are advantageously deactivated (remotely, via the touch-screen terminal) for a use with the aquatic displacement structure of the invention.

The different controls for the starting and the displacement of the mobile described hereinabove will now be described.

### a) Starting

In FIG. 5, the mobile has been illustrated in a situation in which the propulsion unit is stopped. In this case, it rests by the simple effect of gravity against the bridge of the central structure 110, making the transportation and handling thereof easy.

When the propulsion unit is started, for example through a “Start” command button on the touch interface of the control terminal, the four propellers are simultaneously driven in rotation, so as to generate an upward thrust that will tilt the propulsion unit 200 upward and forward about the axis of articulation 318 of the arm 300 (arrow F in FIGS. 5 and 6), until the arm 300 comes in rest against the stop part 320. The final position is illustrated in particular in FIG. 6. From then on, the thrust exerted by the propulsion unit 200 holds this rest all along the displacement, the structure 100 and the propulsion unit 200 being considered as being fixed with respect to each other without the arm 300 has to be locked in any way, and the piloting is ensured as will be seen hereinafter.

It will be noted herein that the speed of rotation of the propellers is advantageously controlled so that the lift movement of the propulsion unit is progressive, avoiding in particular to “hit” too abruptly the stop part 320.

When the propulsion unit is stopped, the force of the gravity brings it back naturally to the position illustrate in FIG. 5. Here again, the stopping is advantageously progressive so as to avoid that the propulsion unit hits too violently the bridge of the central structure 110.

It will be observed herein that this automatic bringing back in flat position of the propulsion unit when the mobile is stopped also allows, by lowering the centre of gravity of the whole mobile, to prevent the latter from tilting.

### b) Control of Progression

The four propellers 221-224 being located in a plan close to the vertical, they generate a thrust that may be varied manually by means of the control terminal, which, according to the actions of the user (touch action or inclination of the terminal), sends by the wireless link the rotational speed instructions to the respective motors of the propellers.

### c) Control of Direction

This control, here again in response to manual actions of the user at the control terminal, is based on potentially different rotation instructions sent to the motors of the left propellers 221, 222 and to the motors of the right propellers 223, 224. The differential drive is preferably proportional, to perform more or less pronounced bends. Here again, it may be an action on the touch interface or a more or less pronounced inclination of the terminal. It has been seen hereinabove that the use of a propulsion unit with several propellers on either side of the axis of displacement of the mobile allowed to do without any rudder or other physical-displacement directional member.

### d) Control of the Thrust Distribution

It is understood that by driving in a differentiated manner the rotation of the upper propellers 221, 223 and the rotation of the lower propellers 222, 224, it is possible to act on the position where the cumulated thrust of the four propellers is exerted.

When the rotational speeds are identical, the thrust is exerted at the geometric centre of the propellers.

When the distribution of the speeds is different, the centre of thrust moves upward (faster rotation of the upper propellers) or downward (faster rotation of the lower propellers). It results therefrom a variation of the value of the moment exerted by the propulsion unit 200 to the mobile. Hence, by a suitable drive of the speeds of the upper and lower propellers, it is possible to adjust the pitch attitude of the mobile. This drive may be performed either manually on the control terminal (touch interface or change of inclination of the tablet), or automatically to stabilize the attitude of the mobile, with a control bop based on the signals provided by the inertial sensors equipping the propulsion unit.

The effect of squat keels of variable attack angle can here again be rendered herein although the keels are fixed.

It has been described herein a mobile intended to move on water by being driven by the propulsion unit. It is however possible to adapt the structure 100 so that the mobile can move on snow or on ice.

Hence, FIG. 7 illustrates a mobile where the keels 122g, 122d, 112 and 114 are replaced by ski-shaped pads, 422g, 422d and 412, respectively, supported by respective struts, for a displacement on snow.

For that purpose, it is advantageous that, in the embodiment described with reference to FIGS. 1 to 6, the squat keels are assembled on the stabilizers and on the central hull in a manner that is easily dismountable (friction fitting, latching, quarter turn screwing, etc.).

FIG. 8 illustrates a variant in which the keels 122g, 122d, 112 and 114 are replaced by curved vertical blades, 522g, 522d and 512, respectively, supported by respective struts, for a displacement on ice.

Advantageously, the rear ski 412 or the rear pad 512 may pivot about a vertical axis, to facilitate the changes of direction.

Other types of accessories are of course possible.

Of course, the present invention may be subjected to many adjustments, variants and modifications. In particular:
the drone that is used as a propulsion unit may be subjected to adaptations: in particular, taking into account a use in an attitude different from that for which it is normally intended (practically vertical plane of propellers, whereas it is horizontal in drone mode), it may be necessary to adjust the transmission/reception antenna equipping the drone to improve the transmission of the signals between it and the control station;
the flotation and navigation structure may have sizes in a wide range, adapted to the type of propulsion unit it receives (for example, a length and a width of a few tens of centimetres, up to one metre or more);
the propulsion unit, to ensure the piloting in direction and attitude, may include a variable number of propellers, with at minimum three propellers (for example two left and right lower propellers and one central upper propeller), but particularly preferably four propellers, as illustrated.

1. A mobile comprising a gliding static structure (100) provided in a lower region with a set of gliding elements (110, 120g, 120d; 122g, 122d, 112, 114; 422g, 422d, 412; 522g, 522d, 512),
characterized in that it further comprises means (300) for the removable mounting of a rotary-wing drone with multiple rotors (221-224) forming a propulsion unit (200), the rotors being adapted to each exert a thrust with a component according a main axis (X-X) of gliding of the mobile, the proportional and individualized drive of the rotors (221-224) allowing to pilot the mobile in speed and direction.

2. The mobile of claim 1, wherein the gliding static structure (100) is a mechanical structure devoid of orientable directional member.

3. The mobile of claim 1, wherein the gliding static structure (100) is a mechanical structure devoid of electronic propulsion and/or direction control and driving means.

4. The mobile of claim 1, wherein the drone is a pre-existing multicopter or a quadricopter used with no other modification than the adaptation of its control software to the progression and the direction of the mobile.

5. The mobile of claim 1, wherein the mounting means comprise an arm (300) articulated about an axis (318) transverse to the main axis (X-X) of gliding of the mobile.

6. The mobile of claim 5, wherein the arm is free in rotation, and in that stop means (320, 322) are provided for retaining the propulsion unit in a wording position fixed with respect to the structure (100) when the rotors are driven into rotation, the rotors being adapted to generate a thrust with a component in the main axis of gliding of the mobile.

7. The mobile of claim 6, wherein, when the drone is a quadricopter, the rotors (221-224) are able, driven into rotation, to progressively make, under the only effect of their thrust, the propulsion unit (200) switch from a storing position to said working position.

8. The mobile of claim 1, wherein, when the drone is a quadricopter, in working position, a differentiated drive of two pairs of rotors (221, 222; 223, 224) located on the left and the right, respectively, with respect to the main axis of displacement is adapted to control the mobile in direction without having to control the orientation of a rear squat keel.

9. The mobile of claim 1, wherein, when the drone is a quadricopter, in working position, a differentiated drive of two pairs of rotors (221, 222; 223, 224) located farther from and closer to the structure (100), respectively, is adapted to control the mobile in attitude.

10. The mobile of claim 1, wherein, when the structure (100) is adapted to an aquatic displacement and has squat keels (122g, 122d, 112, 114).

11. The mobile of claim 10, comprising at least one front squat keel (122g, 122d) with a positive incidence angle.

12. The mobile of claim 10, comprising at least one rear squat keel (114) with a negative incidence angle.

13. The mobile of claim 10, comprising two front squat keels (122g, 122d) forming together a “V” configuration.

14. The mobile of claim 13, wherein the front squat keels are mounted on two lateral stabilizers (120g, 120d) extending from a main central structure, oriented angularly downward and towards each other.

15. The mobile of claim 10, comprising a rear squat keel (112, 114) in an inverted “T” shape.

16. The mobile of claim 10, wherein the structure defines at least one front floating volume (110, 120g, 120d) adapted to oppose a moment exerted by the thrust of the propulsion unit, tending to give it a diving attitude.

17. The mobile of claim 10, wherein the centre of gravity (G) of the mobile is located behind a centre (C) of application of the thrust of the propulsion unit (200) with respect to the main axis (X-X) of gliding of the mobile.

18. The mobile of claim 1, comprising a set of at least three pads (422g, 422d, 412) for a displacement on snow.

19. The mobile of claim 1, comprising a set of at least three blades (522g, 522d, 512) for a displacement on ice.

20. The mobile of claim 18, comprising means for the removable mounting of the keels (122g, 122g, 112, 114), adapted to alternatively receive the pads or the blades.

21. The mobile of claim 19, comprising means for the removable mounting of the keels (122g, 122g, 112, 114), adapted to alternatively receive the pads or the blades.
